(19) United States
(12) Patent Application Publication
(10) Pub. No.: US 2016/0117350 A1
(43) Pub. Date: Apr. 28, 2016

(54) COLUMN GROUP SELECTION METHOD AND APPARATUS FOR EFFICIENTLY STORING DATA IN MIXED OLAP/OLTP WORKLOAD ENVIRONMENT

(71) Applicant: Electronics and Telecommunications Research Institute, Daejeon (KR)

(72) Inventor: Kyoung Hyun PARK, Daejeon (KR)

(21) Appl. No.: 14/920,399

(22) Filed: Oct. 22, 2015

(30) Foreign Application Priority Data
Oct. 22, 2014 (KR) 10-2014-0143399

(51) Int. Cl. G06F 17/30

(52) U.S. Cl. CPC G06F 17/30315; G06F 17/30563; G06F 17/30292; G06F 17/30327; G06F 17/30592; G06F 17/30424

(57) ABSTRACT

Disclosed is a technology for data storage management in a database system, and more particularly, a data storage technology for a mixed OLAP/OLTP workload. A column group selection apparatus for efficiently storing data in a mixed workload processing environment includes a query processor configured to create column access information about queries that are input, a page monitoring module configured to create page-specific query pattern information using information about a page at which each of the input queries accesses and the column access information, a page layout manager configured to create page column group information in which a column group to be used to form each page is selected by applying a tree-based algorithm for selecting a column group to the page-specific query pattern information, and a data storage manager configured to create and store pages in units of column groups based on the page column group information.

### CROSS-REFERENCE TO RELATED APPLICATION

This application claims priority to and the benefit of Korean Patent Application No. 10-2014-0143399, filed on Oct. 22, 2014, the disclosure of which is incorporated herein by reference in its entirety.

### BACKGROUND

1. Field of the Invention

The present invention relates to a technology for storing and managing data in a database system, and more particularly, to a data storage technology for mixed OLAP/OLTP workload processing.

2. Discussion of Related Art

A database system has been divided and developed in two forms of database systems, such as an Online Transaction Processing (OLTP) system and an Online Analytical Processing (OLAP) system depending on a target to be processed. However, with an increasing need to simultaneously process the OLTP and the OLAP in the database markets, a database system for processing a mixed workload has been developed in the academic world and the industrial world.

In the industrial world, the development of database systems is progressing in such a way that an OLTP database engine and an OLAP database engine are separately configured in a database system to process OLAP and OLAP workloads. A representative example of the hybrid database system includes an HANA system of SAP.

In the academic world, studies of database systems which is a still initial stage, but have been conducted on a system capable of processing OLAP and OLTP workloads through a single database engine without providing a separate dedicated database engine. A representative example of the system includes an HYRISE system.

A system for processing a mixed workload has a characteristic in that it supports a dynamic page storage model. The existing database systems operate based on NSM (N-ary Storage Model) that is a static page storage model. An NSM model stores data in units of records and thus has superior performance in processing an OLTP workload, but has poor performance in processing an OLAP workload which accesses certain columns in a large amount of data.

In order to efficiently process an OLAP workload, a column store has been developed. The column store is a system for not storing data in units of records, but dividing and storing data in units of columns, and has superior performance in processing an OLAP workload.

Both of the existing database system for storing data in units of records, which is referred to as a row store, and the column store operate based on a static page storage model. Accordingly, once a page storage model is determined, it is not changed. In addition, data is stored in the defined page model.

The static page storage model may have superior performance in processing a certain query pattern, but it is difficult to provide constant performance in processing workloads having various query patterns.

Accordingly, in order to efficiently process a mixed workload, there is a need for a dynamic page storage model capable of reflecting the characteristics of workloads. The dynamic page storage model analyzes a workload desired to be processed, and periodically reconfigures column groups in a page according to the characteristics of the analyzed workload. Accordingly, the dynamic page storage model processes a user's query in a more efficient manner.

In general, the dynamic page storage model operates based on a Data Morphing page model. The Data Morphing page model provides a method for storing pages in a dynamic manner by suggesting a cost model and the Hill-Climb algorithm that is a column group selection algorism.

However, since the column group selection algorithm suggested by Data Morphing is a candidate-based algorithm, the amount of computation is exponentially increased in proportion to the number of columns forming a table. Accordingly, it is difficult to apply an OLAP database including hundreds of columns.

An HYRISE system is not a relational database, but suggests a column group selection algorithm for dividing and storing data in units of column groups. A column group selection algorithm used in the HYRISE system is considered superior to the column selection algorithm of Data Morphing, but the column group selection algorithm of the HYRISE system is also a candidate-based algorithm, so there is the same limitation as in the Data Morphing algorithm when the number of columns forming a table is increased.

### SUMMARY OF THE INVENTION

The present invention is directed to a column group selection method for efficiently storing data in a mixed workload processing environment, capable of efficiently reducing the computation cost in selecting a column group by applying a tree-based algorithm to the selecting of a column group in a dynamic page storage model, and an apparatus using the same.

The present disclosure is not limited to the purposes described above, and other purposes not described above can be understood to the skilled in the art through the description in this disclosure.

According to an aspect of the present invention, there is provided a column group selection apparatus for efficiently storing data in a mixed workload processing environment, the column group selection apparatus including a query processor, a page monitoring module, a page layout manager and a data storage manager. The query processor may be configured to create column access information about queries that are input. The page monitoring module may be configured to create page-specific query pattern information using information about a page at which each of the input queries accesses and the column access information. The page layout manager may be configured to create page column group information in which a column group to be used to form each page is selected by applying a tree-based algorithm for selecting a column group to the page-specific query pattern information. The data storage manager may be configured to create pages in units of column groups based on the page column group information and store data.

The page layout manager may create a query-specific column list of columns at which the input query accesses, and calculate the number of access frequencies at which the input query accesses each of the columns forming the query-specific column list.

The page layout manager may create a reference column list in which the number of access frequencies at which the input query accesses each of the columns forming the query-specific column list is compared with a predetermined threshold number of frequencies, and columns that are determined to have the number of access frequencies equal to or higher than the predetermined threshold number of frequencies based on a result of the comparison are arranged in order of the number of access frequencies.

The page layout manager may create, for each query, an ordered column list in which the columns forming the query-specific column list are sequentially arranged based on the reference column list, and columns that are not present in the reference column list are deleted from the query-specific column list.

The page layout manager may create a column tree in which columns forming the ordered column list created for each query are disposed at at least one parent node and at least one child node with respect to a root node.

The page layout manager may dispose the columns forming the ordered column list created for each query to the parent node and the child node in order of the number of access frequencies.

The page layout manager may connect the parent node or child node having the same column name in the column tree as a linked list.

The page layout manager may create a column header table including a column name of a representative node that is used to identify each node forming the column tree and address information about the representative node.

The page layout manager may create a conditional pattern base including a column pattern which is to be composed by each of the columns forming the corresponding column tree and the number of access frequencies at which each of the input queries accesses the column pattern, for each of the columns, based on the column tree.

The page layout manager may create a final column tree for each of the conditional pattern bases by repeatedly performing a process of creating a new column tree and a new conditional pattern base based on each of the conditional pattern bases until no more column tree is created.

The page layout manager may create all possible combinations of column groups based on the final column tree created for each of the conditional pattern bases, calculate a cost model for each of the combinations of column groups, and select a combination of column groups having a minimum cost model

According to another aspect of the present invention, there is provided a column group selection method for efficiently storing data in a mixed workload processing environment, the column group selection method including: creating column access information about queries that are input; creating page-specific query pattern information using information about a page at which each of the input queries accesses and the column access information; creating page column group information in which a column group to be used to form each page is selected by applying a tree-based algorithm for selecting a column group to the page-specific query pattern information; and creating pages in units of column groups based on the page column group information and storing data.

According to another aspect of the present invention, there is provided a column group selection method for efficiently storing data in a mixed workload processing environment, the column group selection method including: creating a query-specific column list of columns at which an input query accesses, and calculating the number of access frequencies at which the input query accesses each of the columns forming the query-specific column list; creating a reference column list in which the number of access frequencies at which the input query accesses each of the columns forming the query-specific column list is compared with a predetermined threshold number of frequencies, and columns that are determined to have the number of access frequencies equal to or higher than the predetermined threshold number of frequencies based on a result of the comparison are arranged in order of the number of access frequencies; creating, for each query, an ordered column list in which the columns forming the query-specific column list are sequentially arranged based on the reference column list, and columns that are not present in the reference column list are deleted from the query-specific column list; creating a column tree in which columns forming the ordered column list created for each query are disposed at at least one parent node and at least one child node with respect to a root node; creating a conditional pattern base including a column pattern which is to be composed by each of the columns forming the corresponding column tree and the number of access frequencies at which each of the input queries accesses the column pattern, for each of the columns, based on the column tree; creating a final column tree for each of the conditional pattern bases by repeatedly performing a process of creating a new column tree and a new conditional pattern base based on each of the conditional pattern bases until no more column tree is created; and creating all possible combinations of column groups based on the final column tree created for each of the conditional pattern bases, calculating a cost model for each of the combinations of column groups, and selecting a combination of column groups having a minimum cost model.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a column group selection apparatus for efficiently storing data in a mixed workload processing environment in accordance with an exemplary embodiment of the present invention;

FIG. 2 is a diagram illustrating an example of page column group information created based on page monitoring information in accordance with an exemplary embodiment of the present invention;

FIGS. 3A and 3B are flowcharts showing a process of creating page column group information in a page layout manager of FIG. 1;

FIG. 4 is a diagram illustrating an example of a reference column list created in a reference column list creation operation of FIG. 3;

FIG. 5 is a diagram illustrating an example of an ordered column list with respect to each query in an ordered column list creation operation of FIG. 3;

FIG. 6 is a diagram illustrating an example of a column tree and a column header table that are created based on an ordered column list in a column tree creation operation of FIGS. 3A and 3B;

FIG. 7 is a diagram illustrating an example of column lists composed by columns and frequencies of columns in a conditional pattern base creation operation of FIG. 3;

FIG. 8 is a diagram illustrating an example of a column group extracted from f-conditional pattern base in an operation of creating column tree based on conditional patterns as shown in FIGS. 3A and 3B; and

FIG. 9 is a diagram illustrating a process of creating a combination of column groups having a minimum cost model among combinations of column groups created in column group information creation of FIGS. 3A and 3B.

### DETAILED DESCRIPTION OF EXEMPLARY EMBODIMENTS

The above and other advantages, and a scheme for the advantages of the present invention will become readily apparent by reference to the following detailed description when considered in conjunction with the accompanying drawings. However, the scope of the present invention is not limited to such embodiments and the present invention may be realized in various forms. The embodiments to be described below are nothing but the ones provided to bring the disclosure of the present invention to perfection and assist those skilled in the art to completely understand the present invention. The present invention is defined only by the scope of the appended claims. Meanwhile, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail below with reference to the accompanying drawings. The same reference numerals are used to designate the same elements throughout the drawings. In the following description of the present invention, a detailed description of known functions and configurations incorporated herein will be omitted when it may make the subject matter of the present invention rather unclear.

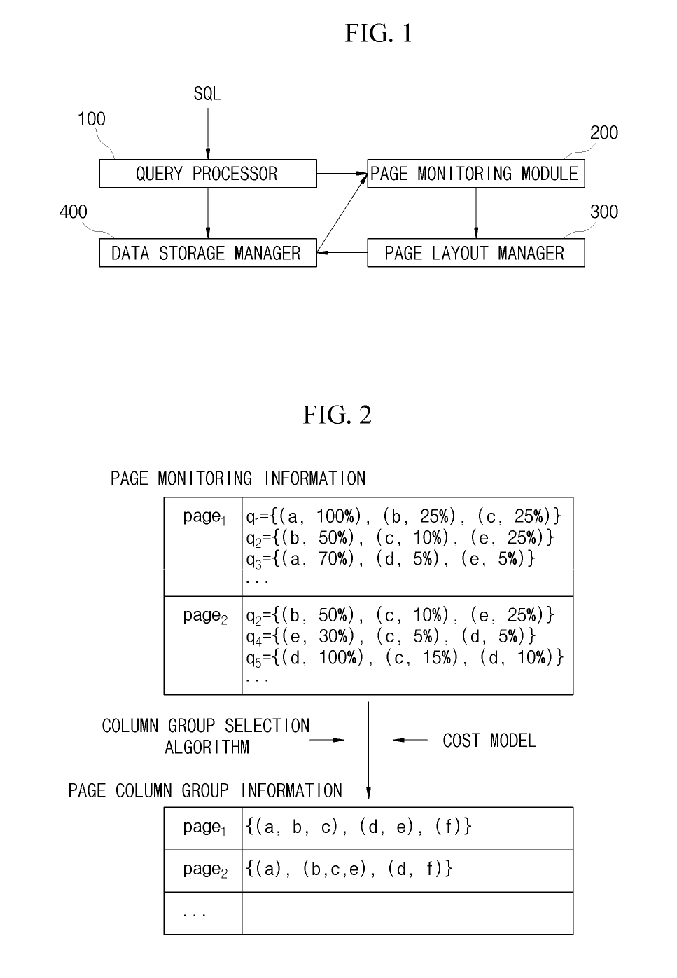

FIG. 1 is a block diagram illustrating a column group selection apparatus for efficiently storing data in a mixed workload processing environment in accordance with an exemplary embodiment of the present invention.

Referring to FIG. 1, a column group selection apparatus for efficiently storing data in a mixed workload processing environment in accordance with an exemplary embodiment of the present invention includes a query processor 100, a page monitoring module 200, a page layout manager 300, and a data storage manager 400.

The query processor 100 creates column access information about queries that are input to a database system.

The page monitoring module 200 creates page-specific query pattern information by receiving the column access information from the query processor 100 and receiving information about a page at which each of the input queries accesses from the data storage manager 400, and transmits the page-specific pattern information to the page layout manager 300.

The page layout manager 300 creates page column group information in which a column group to be used to form each page is selected based on the page-specific query pattern information.

The page layout manager 300 creates pages in units of column groups based on the page column group information and stores data.

The conventional database system for storing data in units of records processes data through a query processor and a data storage manager, whereas the database system according to an exemplary embodiment of the present invention further is characterized in analyzing a workload and periodically creating a column group and transmitting the results thereof to the data storage manager by including a page monitoring module and a page layout manager to store pages in a dynamic manner.

In addition, the database system according to an exemplary embodiment of the present invention is characterized in remarkably reducing the calculation cost by applying a tree-based algorithm upon the selection of a column group in the page layout manager.

FIG. 2 is a diagram illustrating an example of page column group information created based on page monitoring information in accordance with an exemplary embodiment of the present invention.

Referring to FIG. 2, the page layout manager 300 uses page monitoring information in order to create page column group information. The page monitoring information includes information about a column at which each query accesses for each page. For example, information indicating that query q1 accesses columns a, b and c and query q2 access columns b, c and d on page 1 is provided as page monitoring information.

The page layout manager 300 selects a column group at which a query accesses at a high number of access frequencies, based on the page monitoring information. In this regard, a cost model calculation and a column group selection algorithm are applied upon the selecting of a column group, and the column group selection algorithm in accordance with an exemplary embodiment of the present invention is implemented as a tree-based data structure.

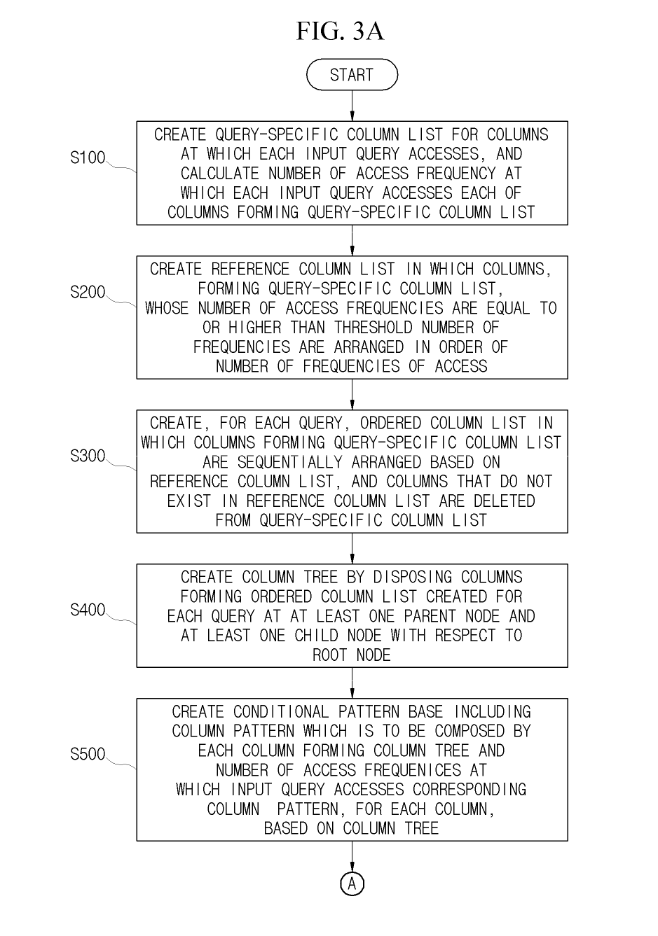

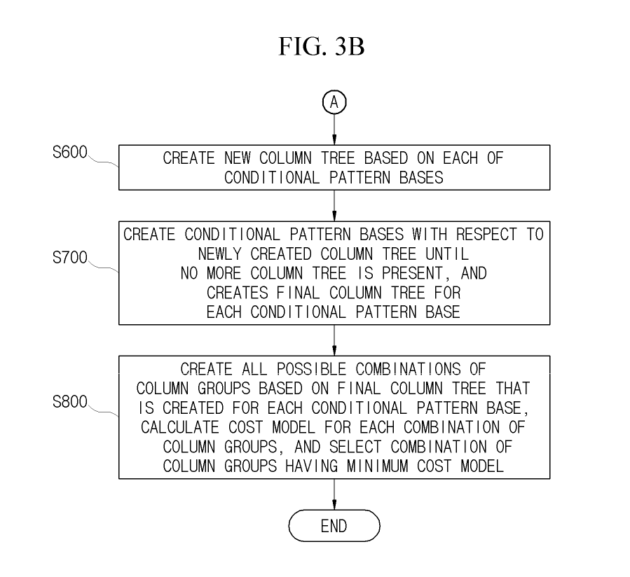

Hereinafter, a process of creating column group information in the page layout manager 300 in accordance with an exemplary embodiment of the present invention will be described with reference to FIGS. 3 to 9.

FIGS. 3A and 3B are flowcharts showing a process of creating page column group information in the page layout manager of FIG. 1.

Referring to these FIGS. 3A and 3B, the page layout manager 300 creates a query-specific column list of columns at which each of the input queries accesses, and calculates the number of access frequencies at which the input query accesses each of the columns forming the query-specific column list (S100).

Thereafter, the page layout manager 300 compares the number of access frequencies at which the input query accesses each of the columns forming the query-specific column list with the predetermined threshold number of frequencies, and creates a reference column list by arranging columns that are determined to have the number of access frequencies equal to or higher than the predetermined threshold number of frequencies based on a result of the comparison in order of the number of access frequencies (S200).

Since the embodiment of the present invention focuses on only the columns at which the query accesses at a high number of access frequencies, columns having the number of access frequencies below a predetermined threshold are excluded in the reference column list. Accordingly, the reference column list sequentially stores columns starting from a column having the highest number of access frequencies.

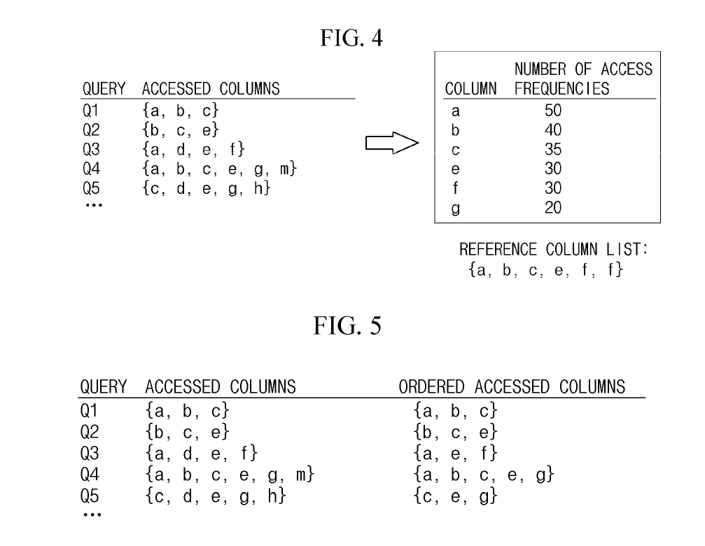

FIG. 4 is a diagram illustrating an example of a reference column list created in the reference column list creation operation of FIGS. 3A and 3B.

For example, when it is assumed that query q₁ accesses columns a, b and c, and query q₅ accesses columns c, d, e, g and h, a column list {a, b, c} is created with respect to query qᵢ and a column list {c, d, e, g, h} is created with respect to query q₅.

As described above, a column list is created with respect to each of all queries (q₁, q₂, . . . ) within a certain page, and the number of access frequencies at which a query (q₁, q₂, . . . ) accesses each column forming the column list is calculated. The column list is arranged in order of the number of access frequencies, and an element having the number of access frequencies equal to or higher than a predetermined threshold value is left in the column list, and the remaining elements are deleted from the column list.

For example, when it is assumed that a predetermined reference value to create a reference column list is 20, columns calculated as having the number of access frequencies equal to or higher than 20 are columns a, b, c, e, f and g, and a reference column list is created by sequentially arranging the columns a, b, c, e, f and g starting from column a having the highest number of access frequencies.

Thereafter, the page layout manager 300 arranges the columns forming the query-specific column list, based on the reference column list, and deletes columns that do not exist in the reference column list from the query-specific column list, thereby creating an ordered column list for each query (S300).

FIG. 5 is a diagram illustrating an example of an ordered column list with respect to each query in the ordered column list creation operation of FIGS. 3A and 3B.

For example, it may be assumed that a column list {a, b, c, e, g, m} is created with respect to query q₄, and in operation S200, a reference column list {a, b, c, e, f, g} is created.

Column m that does not exist in the reference column list is deleted from the column list {a, b, c, e, g, m}, and the remaining columns a, b, c, e and g are ordered based on the reference column list to create an ordered column list {f, c, a, m, p}.

The same process as the above is applied to each of the remaining queries, and ordered column lists are created for the respective queries as shown in FIG. 5.

Thereafter, the page layout manager 300 creates a column tree in which columns forming the ordered column list created for each query are disposed at at least one parent node and at least one child node with respect to a root node (S400).

The column tree is created such that a column having a highest number of access frequencies is disposed at a parent node and a column having a following number of access frequencies is disposed at a child node with respect to a root node.

In addition, a parent node or child node having the same column name in the column tree is connected as a linked list, so that the column nodes (referring to a parent node or a child node) having the same column name may be sequentially found.

In addition, the page layout manager 300 creates a column header table including a column name of a representative node that is used to identify each node forming the column tree and address information about the representative node.

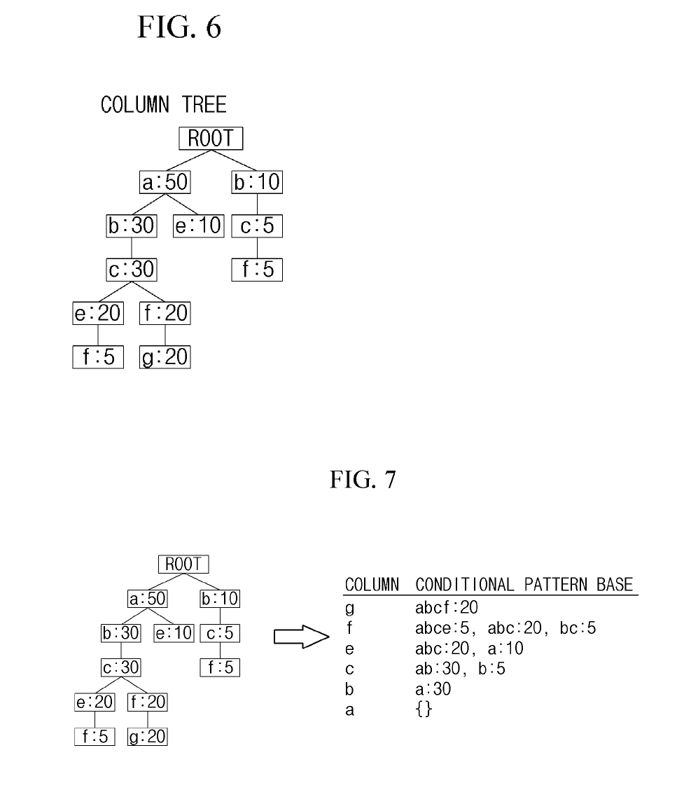

FIG. 6 is a diagram illustrating an example of a column tree and a column header table that are created based on an ordered column list in the column tree creation operation of FIGS. 3A and 3B.

For example, the number of cases obtained when column a is disposed foremost is 50, and the number of cases obtained when columns a, b and c are sequentially disposed in order of a, b and c is 30, and the number of cases obtained when columns a, b, c and e are sequentially disposed in order of a, b, c and e is 20. At this time, column f having the highest number of access frequencies is disposed at the uppermost parent node with respect to a root node, and subsequently, columns b and c are disposed at children nodes with respect to column a.

Thereafter, the page layout manager 300 creates a conditional pattern base including a column pattern which is to be composed by each of the columns forming the corresponding column tree and the number of access frequencies at which each of the input queries accesses the column pattern, for each of the columns, based on the column tree (S500).

The conditional pattern base is composed by a column list and a frequency that are provided when each column is given. FIG. 7 is a diagram illustrating an example of column lists composed by columns and the numbers of access frequencies of columns in the conditional pattern base creation operation of FIGS. 3A and 3B.

As to create a conditional pattern base with respect to column f, columns to be composed together with column f are columns a, b, c and e, columns a, b and c, or columns b and c in the column tree created in operation S400.

The number of access frequencies of columns a, b, c and e as well as column f is 5, which is smaller than a threshold value, so no more computation is performed. The number of access frequencies of columns a, b and c as well as column f is 20, so f- conditional tree is created.

The page layout manager 300 may perform a process of creating new column trees from conditional pattern bases with respect to all of the columns forming the reference column list (S600), and based on each of the new column trees, creating new conditional pattern bases with respect to all columns. The process is repeatedly performed until no more column tree is created (S700).

That is, the page layout manager 300 repeatedly performs a process of creating new column trees and new conditional pattern bases based on each of the conditional pattern bases until no more column tree is created. Accordingly, a final column tree is created for each of the conditional pattern bases.

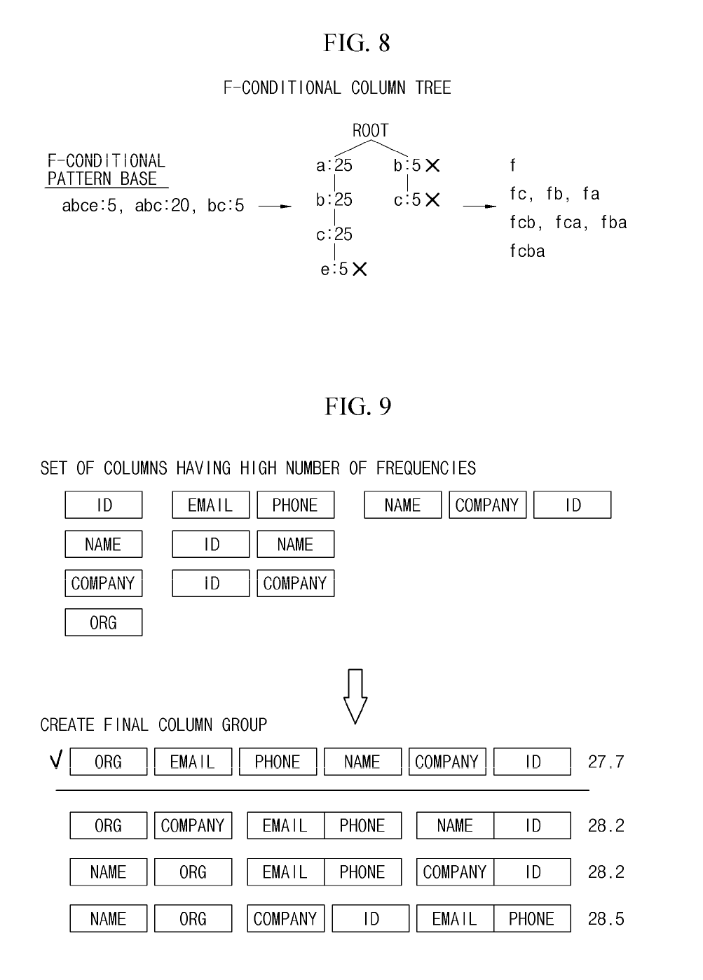

Through the process which is repeatedly performed, a set of columns having a high number of access frequencies is finally extracted. FIG. 8 is a diagram illustrating an example of a column group extracted from f-conditional pattern base in an operation of creating column tree based on conditional patterns as shown in FIGS. 3A and 3B.

Thereafter, the page layout manager 300 creates all possible combinations of column groups based on the final column tree that is created for each of the conditional pattern bases, calculates a cost model for each of combinations of column groups, and selects a combination of column groups having a minimum cost model (S800).

FIG. 9 is a diagram illustrating a process of creating a combination of column groups having a minimum cost model among combinations of column groups created in column group information creation of FIGS. 3A and 3B.

Referring to FIG. 9, the page layout manager 300 calculates cost models of all combinations obtained with respect to column groups. A combination of column groups having the minimum cost model is selected as a final column group combination.

As described above, column groups are created from columns having a high number of access frequencies based on a tree-data structure, and a cost model is applied to the column groups, so that the optimum column group is selected. Accordingly, the computation cost taken to select column groups is efficiently reduced compared to the conventional candidate-based column group calculation.

As is apparent from the above, according to the present invention, when a page is dynamically configured in a database system, the operation cost for selecting column groups can be remarkably reduced because column groups is selected by applying a tree-based algorithm

It will be apparent to those skilled in the art that various modifications can be made to the above-described exemplary embodiments of the present invention without departing from the spirit or scope of the invention. The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims.

What is claimed is:

1. A column group selection apparatus for efficiently storing data in a mixed workload processing environment, the column group selection apparatus comprising:
a query processor configured to create column access information about queries that are input;
a page monitoring module configured to create page-specific query pattern information using information about a page at which each of the input queries accesses and the column access information;
a page layout manager configured to create page column group information in which a column group to be used to form each page is selected by applying a tree-based algorithm for selecting a column group to the page-specific query pattern information; and
a data storage manager configured to create pages in units of column groups based on the page column group information, and store data.

2. The column group selection apparatus of claim 1, wherein the page layout manager creates a query-specific column list of columns at which the input query accesses, and calculates the number of access frequencies at which the input query accesses each of the columns forming the query-specific column list.

3. The column group selection apparatus of claim 2, wherein the page layout manager creates a reference column list in which the number of access frequencies at which the input query accesses each of the columns forming the query-specific column list is compared with a predetermined threshold number of frequencies, and columns that are determined to have the number of access frequencies equal to or higher than the predetermined threshold number of frequencies based on a result of the comparison are arranged in order of the number of access frequencies.

4. The column group selection apparatus of claim 3, wherein the page layout manager creates, for each query, an ordered column list in which the columns forming the query-specific column list are sequentially arranged based on the reference column list, and columns that are not present in the reference column list are deleted from the query-specific column list.

5. The column group selection apparatus of claim 4, wherein the page layout manager creates a column tree in which columns forming the ordered column list created for each query are disposed at at least one parent node and at least one child node with respect to a root node.

6. The column group selection apparatus of claim 5, wherein the page layout manager disposes the columns forming the ordered column list created for each query at the parent node and the child node in order of the number of access frequencies.

7. The column group selection apparatus of claim 5, wherein the page layout manager connects the parent node or child node having the same column name in the column tree as a linked list.

8. The column group selection apparatus of claim 5, wherein the page layout manager creates a column header table including a column name of a representative node that is used to identify each node forming the column tree and address information about the representative node.

9. The column group selection apparatus of claim 5, wherein the page layout manager creates a conditional pattern base including a column pattern which is to be composed by each of the columns forming the corresponding column tree and the number of access frequencies at which each of the input queries accesses the column pattern, for each of the columns, based on the column tree.

10. The column group selection apparatus of claim 9, wherein the page layout manager creates a final column tree for each of the conditional pattern bases by repeatedly performing a process of creating a new column tree and a new conditional pattern base based on each of the conditional pattern bases until no more column tree is created.

11. The column group selection apparatus of claim 10, wherein the page layout manager creates all possible combinations of column groups based on the final column tree created for each of the conditional pattern bases, calculates a cost model for each of the combinations of column groups, and selects a combination of column groups having a minimum cost model.

12. A column group selection method for efficiently storing data in a mixed workload processing environment, the column group selection method comprising:
creating column access information about queries that are input;
creating page-specific query pattern information using information about a page at which each of the input queries accesses and the column access information;
creating page column group information in which a column group to be used to form each page is selected by applying a tree-based algorithm for selecting a column group to the page-specific query pattern information; and
creating pages in units of column groups based on the page column group information and storing data.

13. The column group selection method of claim 12, wherein the creating of the page column group information comprises:
creating a query-specific column list of columns at which the input query accesses, and calculating the number of access frequencies at which the input query accesses each of the columns forming the query-specific column list; and
creating a reference column list in which the number of access frequencies at which the input query accesses each of the columns forming the query-specific column list is compared with a predetermined threshold number of frequencies, and columns that are determined to have the number of access frequencies equal to or higher than the predetermined threshold number of frequencies based on a result of the comparison are arranged in order of the number of access frequencies.

14. The column group selection method of claim 13, wherein the creating of the page column group information comprises:
creating, for each query, an ordered column list in which the columns forming the query-specific column list are sequentially arranged based on the reference column list, and columns that are not present in the reference column list are deleted from the query-specific column list; and
creating a column tree in which columns forming the ordered column list created for each query are disposed at at least one parent node and at least one child node with respect to a root node.

15. The column group selection method of claim 14, wherein the creating of the page column group information comprises
creating a conditional pattern base including a column pattern which is to be composed by each of the columns forming the corresponding column tree and the number of access frequencies at which each of the input queries accesses the column pattern, for each of the columns, based on the column tree; and
creating a final column tree for each of the conditional pattern bases by repeatedly performing a process of creating a new column tree and a new conditional pattern base based on each of the conditional pattern bases until no more column tree is created.

16. The column group selection method of claim 15, wherein the creating of the page column group information comprises
creating all possible combinations of column groups based on the final column tree created for each of the conditional pattern bases, calculating a cost model for each of the combinations of column groups, and selecting a combination of column groups having a minimum cost model.

17. A column group selection method for efficiently storing data in a mixed workload processing environment, the column group selection method comprising:
creating a query-specific column list of columns at which queries that are input access, and calculating the number of access frequencies at which each of the input queries accesses each of the columns forming the query-specific column list;
creating a reference column list in which the number of access frequencies at which the input query accesses each of the columns forming the query-specific column list is compared with a predetermined threshold number of frequencies, and columns that are determined to have the number of access frequencies equal to or higher than the predetermined threshold number of frequencies based on a result of the comparison are arranged in order of the number of access frequencies;
creating, for each query, an ordered column list in which the columns forming the query-specific column list are sequentially arranged based on the reference column list, and columns that are not present in the reference column list are deleted from the query-specific column list;
creating a column tree in which columns forming the ordered column list created for each query are disposed at at least one parent node and at least one child node with respect to a root node;
creating a conditional pattern base including a column pattern which is to be composed by each of the columns forming the corresponding column tree and the number of access frequencies at which each of the input queries accesses the column pattern, for each of the columns, based on the column tree;
creating a final column tree for each of the conditional pattern bases by repeatedly performing a process of creating a new column tree and a new conditional pattern base based on each of the conditional pattern bases until no more column tree is created; and
creating all possible combinations of column groups based on the final column tree created for each of the conditional pattern bases, calculating a cost model for each of the combinations of column groups, and selecting a combination of column groups having a minimum cost model.

18. The column group selection method of claim 17, wherein the creating of the column tree comprises disposing the columns forming the ordered column list created for each query to the parent node and the child node in order of the number of access frequencies.

19. The column group selection method of claim 17, wherein the creating of the column tree comprises connecting the parent node or child node having the same column name in the column tree as a linked list.

20. The column group selection method of claim 17, wherein the creating of the column tree comprises creating a column header table including a column name of a representative node that is used to identify each node forming the column tree and address information about the representative node.
